(19) United States
(12) Patent Application Publication
(10) Pub. No.: US 2020/0284608 A1
(43) Pub. Date: Sep. 10, 2020

(54) SYSTEMS AND METHODS TO PROVIDE CAUTIONARY DRIVING NOTIFICATIONS

(71) Applicant: Ford Global Technologies, LLC, Dearborn, MI (US)

(72) Inventors: Mahmoud Yousef Ghannam, Canton, MI (US); Brian Bennie, Sterling Heights, MI (US); Mark Gehrke, Ypsilanti, MI (US); Jonathan Diedrich, Carleton, MI (US)

(73) Assignee: Ford Global Technologies, LLC, Dearborn, MI (US)

(21) Appl. No.: 16/297,264

(22) Filed: Mar. 8, 2019

(51) Int. Cl. G01C 21/36; B60W 50/14

(52) U.S. Cl. CPC G01C 21/3641; B60W 2050/146; B60W 50/14; G01C 21/3697

(57) ABSTRACT

Exemplary embodiments described in this disclosure are generally directed to systems and methods for providing cautionary driving notifications to a driver of an automobile. The cautionary driving notifications may be generated and stored by the driver himself/herself after driving along a travel route a few times or by a different driver who has driven along the travel route a few times. The notifications, which may be provided in various ways such as by audible warnings or beeps, warn the driver of a driving hazard or a driving limitation that is coming up as the automobile is subsequently driven along the travel route. Some examples of a driving hazard can include a traffic accident or a bad road condition. Some examples of a driving limitation can include a speed limit due to a blind curve in the road or in a school zone during certain times of the day.

### FIELD OF THE DISCLOSURE

This disclosure generally relates to automobiles, and more particularly relates to systems and methods for providing cautionary driving notifications to a driver of an automobile.

### BACKGROUND

Traffic congestion and delays have become increasingly prevalent during daily commutes in many towns and cities, and most drivers have begun to adapt their driving habits accordingly. Some of these driving habits, such as patience and courtesy, are highly desirable, while some others, such as drowsiness, distractions, and annoyance, can be risky. Many drivers try to combat drowsiness by performing activities such as listening to the radio or chatting with passengers (if present). Some of these activities may be effective to some extent. However, even such activities may be unable to combat drowsiness over an extended period of time, particularly when the drive is repetitive and monotonous (such as a daily commute to a place of work). Furthermore, some of these activities may be risky if executed improperly. For example, it can be risky to take one's eyes off the road when operating a car radio, or to turn one's head around to talk to a passenger in a back seat of a car. It is therefore desirable to offer solutions that would address at least some of these issues when driving an automobile.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an exemplary scenario in which cautionary driving notifications may be utilized in an automobile in accordance with the disclosure.

FIG. 2 illustrates an exemplary scenario in which cautionary driving notifications may be utilized in two automobiles in accordance with the disclosure.

FIG. 3 illustrates another exemplary scenario in which cautionary driving notifications may be utilized in two automobiles in accordance with the disclosure.

FIG. 4 illustrates some details of an exemplary communications apparatus that can be used to provide cautionary driving notifications in accordance with the disclosure.

FIG. 5 illustrates a few exemplary devices that may be used to provide cautionary driving notifications in accordance with the disclosure.

FIG. 6 shows a flowchart of a method to provide cautionary driving notifications in accordance with the disclosure.

### DETAILED DESCRIPTION

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular component such as a first processor in a first computer may be performed by another component such as a second processor in another computer. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and terms are used herein solely for convenience and such words and terms should be interpreted as referring to various objects and actions that are generally understood in various forms and equivalencies by persons of ordinary skill in the art. For example, the word “automobile” may be interchangeably used with words such as “vehicle” and “car.” Words such as “travel,” “drive,” and “trip” may also be used interchangeably. The phrase “along a travel route” should be understood to refer to one or more roads used by a driver to travel from one location to another. It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

In terms of a general overview, certain embodiments described in this disclosure are directed to systems and methods for providing cautionary driving notifications to a driver of an automobile. The cautionary driving notifications may be generated and stored by the driver himself/herself after driving along a travel route a few times or by another driver who has driven along the travel route a few times. The notifications, which may be provided in various ways such as by audible warnings or beeps, warn the driver of a driving hazard or a driving limitation that is coming up when the automobile is subsequently driven along the travel route. A few examples of a driving hazard can include a traffic accident or a bad road condition. A few examples of a driving limitation can include a speed limit due to a blind curve in the road or in a school zone during certain times of the day.

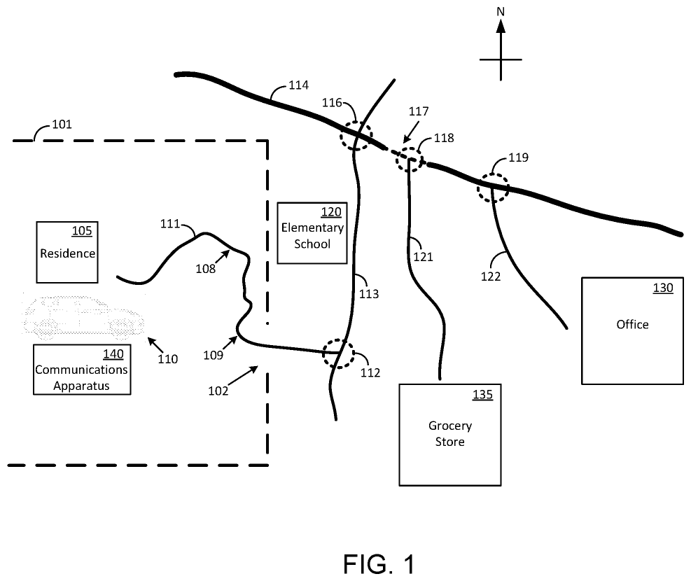

FIG. 1 illustrates an exemplary scenario in which cautionary driving notifications may be utilized in an automobile 110 in accordance with the disclosure. In this example scenario, the automobile 110 is a first automobile that belongs to a person who lives in a residence 105 located in a subdivision 101. This person, referred to hereinafter as a first driver, uses the automobile 110 to drive to work in an office 130 that is located a few miles away from the residence 105. The first driver typically commutes between the residence 105 and the office 130 by driving along a first travel route that includes several roads.

The automobile 110 is also used by the person's spouse during non-work hours to drive to a grocery store 135. Sometimes, a friend who lives in a neighboring house uses the automobile 110 to pick up groceries from the grocery store 135. Either the spouse or the friend, referred to hereinafter as a second driver, typically uses a second travel route to drive from the residence 105 to the grocery store 135 and back. The second travel route used by the second driver includes a part of the first travel route that is used by the first driver.

The first travel route includes several roads including a road 111 that extends from the residence 105 to an entryway 102 of the subdivision 101 and further extends to an intersection 112. The intersection 112 has a traffic light that malfunctions often. Consequently, drivers exiting the subdivision 101 have to be careful when turning onto a second road 113 that leads north to an expressway 114. An elementary school 120 is located beside the second road 113, between the intersection 112 and an intersection 116 that includes an on-ramp and an off-ramp. The on-ramp may be used for merging into traffic traveling eastwards on the expressway 114, and the off-ramp may be used for exiting the expressway 114 when traveling in the opposite direction. The expressway 114 includes a section 117 that is undergoing construction, thus causing drivers to face various driving limitations such as a speed limit and a cautionary warning to watch out for construction workers. The section 117 has an intersection 118 having an off-ramp onto a road 121 that terminates at the grocery store 135. Further east along the expressway 114 is another off-ramp at an intersection 119 that can be used to exit the expressway 114 onto a road 122 leading up to the office 130. An on-ramp is also provided at the intersection 119 for allowing traffic traveling north on the road 122 to merge onto traffic traveling west on the expressway 114.

On a typical work day, the first driver of the automobile 110 heads out to work by driving along the road 111 towards the entryway 102 of the subdivision 101. The road 111 is a winding road having several bends and curves because of various houses located in the subdivision 101. A speed limit is enforced upon all drivers driving down the road 111 so as to protect children and animals that may encroach onto the road 111. The speed limit is in effect all the time.

The first driver of the automobile 110 is concerned that the second driver (spouse or friend) may be distracted by children and neighbors while driving down the road 111 towards the grocery store 135. The first driver of the automobile 110 is particularly concerned about a blind curve 109 in the road 111 and about a school bus stop 108 where neighborhood school children board a school bus during a pick-up time period in the morning and are dropped off during a drop-off time period in the afternoon.

Consequently, in accordance with the disclosure, the first driver of the automobile 110 uses a communications apparatus 140 to generate and store cautionary driving notifications at the blind curve 109, the school bus stop 108, and any other location on the road 111 that the first driver deems fit for providing cautionary driving notifications. The cautionary driving notifications may be used not only by the second driver but also may be used by the first driver as well during subsequent drives in the automobile 110.

The communications apparatus 140 may be implemented in the form of various types of devices. In one exemplary implementation, the communications apparatus 140 is installed in the automobile 110 and is available for use by any driver of the automobile 110. In another exemplary implementation, the communications apparatus 140 is a portable device that can be carried around by the first driver and used for generating and storing cautionary driving notifications. The cautionary driving notifications may be executed in various ways. In one exemplary implementation, the communications apparatus 140 includes a voice interface having a voice recorder that can be used by the first driver to generate and store a cautionary driving notification in the form of an audio message. In another exemplary implementation, the communications apparatus 140 includes an input interface that is used by the first driver to generate and store a cautionary driving notification in the form of an audio tone. The input interface may be a keypad with one or more keys designated for generating and storing the audio tone automatically when depressed. The audio tone may be, for example, a warning beep or a series of warning beeps having an increasing cadence.

The communications apparatus 140 can also have an output interface that includes a speaker for sounding the cautionary driving notification. For example, the communications apparatus 140 can sound a first cautionary driving notification via the output interface every time the automobile 110 approaches the blind curve 109 from either direction during subsequent trips that are executed by either the first driver or the second driver. As another example, the communications apparatus 140 can sound a second cautionary driving notification via the output interface each time the automobile 110 approaches the school bus stop 108 from either direction during subsequent trips that are executed by either the first driver or the second driver. In one exemplary implementation, the second cautionary driving notification is sounded exclusively during the pick-up time period in the morning when neighborhood school children board the school bus and during the drop-off time period in the afternoon when the neighborhood school children get off the school bus. The communications apparatus 140 may be configured to prevent outputting the second cautionary driving notification during other times of the day.

In addition to generating cautionary driving notifications inside the subdivision 101, the first driver of the automobile 110 can generate additional cautionary driving notification at various other locations along the travel route from the subdivision 101 to the office 130. For example, the first driver can generate additional cautionary driving notifications for locations such as the intersection 112 (particularly when the traffic light is malfunctioning), a stretch of road in front of the elementary school 120 where a speed limitation is enforced during certain times of the day, the on-ramp at the intersection 116, a starting location of the section 117 that is undergoing construction, the intersection 118 having an off-ramp onto the road 121, and the intersection 119 having an off-ramp to the road 122. The cautionary driving notifications may be sounded every time the automobile 110 approaches some of the locations such as the intersection 112, the intersection 118, and the intersection 119. However, the cautionary driving notifications may be output only during certain times of the day when the automobile 110 approaches locations such as the stretch of road in front of the elementary school 120, which has a speed limit that is applicable only during certain school hours.

In addition to generating cautionary driving notifications on his/her way to the office 130, the first driver of the automobile 110 can also generate additional cautionary driving notifications at various locations along the travel route while driving back to the residence 105 from the office 130. The various locations on the drive back may be the same, or may be different than the locations at which the cautionary driving notifications were generated while driving from the residence 105 to the office 130.

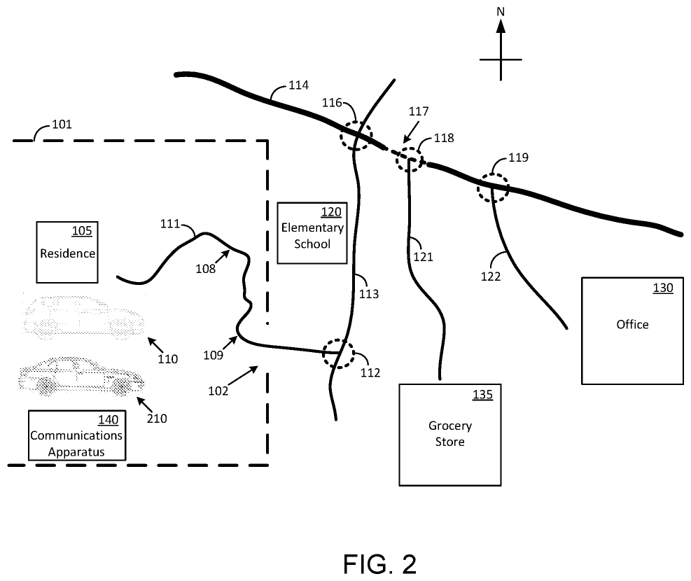

FIG. 2 illustrates an exemplary scenario in which cautionary driving notifications may be utilized in the automobile 110 and another automobile 210 in accordance with the disclosure. For purposes of description, the first driver is referred to hereafter as Bob and the second driver as Jane. Jane (Bob's wife) finds it inconvenient to wait until Bob gets back from work before driving to the grocery store 135. So, Bob and Jane decide to purchase the automobile 210. Jane now uses the automobile 210 for her trips to the grocery store 135 by driving along a portion of the same travel route that Bob takes to travel to his office 130.

In this exemplary scenario, the communications apparatus 140 is a portable device. Bob uses this portable device to generate and store the cautionary driving notifications while using the automobile 110 to drive along the travel route from the residence 105 to his office 130. To ensure accuracy, Bob drives down the travel route several times before generating and storing the cautionary driving notifications. For example, Bob notices during a first trip that the school bus arrives at the school bus stop 108 ten minutes later than a scheduled time indicated by the school authorities. On subsequent trips (over a week, for example), Bob takes note that the school bus is consistently late by ten minutes. Bob now generates and stores a first cautionary driving notification to inform Jane that the school bus arrives late regularly, and also to watch out for neighborhood children running around at the school bus stop 108 at that time.

As another example, Bob notices during the first trip that a construction crew is at work on the section 117 of the expressway 114. It is unclear as to how long the construction work will last. Consequently, Bob does not generate a cautionary driving notification right away. On subsequent trips (over a week, for example), Bob recognizes that the construction work is a significant task and that the section 117 constitutes a driving hazard. Bob therefore generates and stores a second cautionary driving notification to inform Jane of the section 117 and of a closure of the off-ramp at the intersection 118.

Bob hands over the communications apparatus 140 to Jane after having stored the first and second cautionary driving notifications in the communications apparatus 140. Jane uses the communications apparatus 140 subsequently when driving to the grocery store 135 in the automobile 210. When in use, the communications apparatus 140 automatically outputs Bob's first cautionary driving notification as the automobile 210 approaches the school bus stop 108. Jane may slow down and watch out for children upon hearing Bob's first cautionary driving notification. The communications apparatus 140 may automatically output Bob's second cautionary driving notification as the automobile 210 approaches the section 117 on the expressway 114. Upon hearing the second cautionary driving notification, Jane may exit the expressway 114 using an alternative off-ramp and take an alternative route to the grocery store 135.

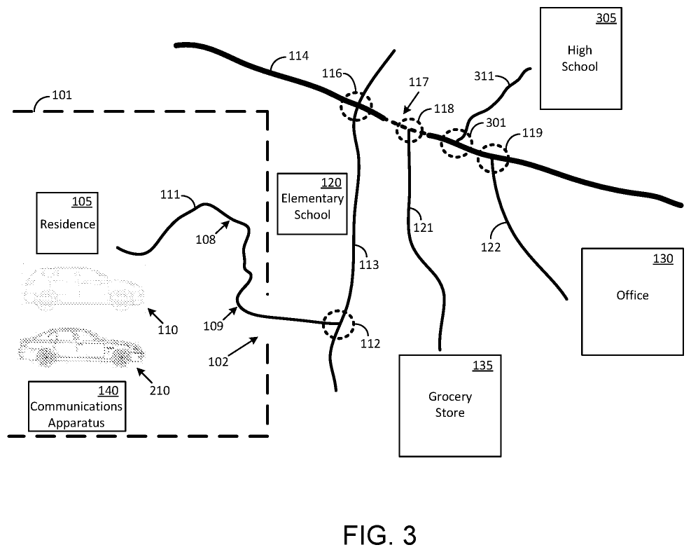

FIG. 3 illustrates another exemplary scenario in which cautionary driving notifications may be utilized in the automobile 110 and the automobile 210 in accordance with the disclosure. In this example scenario, Bob and Jane have a son Patrick who attends a high school 305. Patrick uses the automobile 210 to drive from the residence 105 to the high school 305 on a daily basis. The travel route taken by Patrick is identical to a portion of the travel route taken by Bob. However, Patrick heads north on a road 311 after taking an off-ramp at an intersection 301 on the expressway 114. The intersection 301 is located ahead of the intersection 119 at which Bob gets off the expressway 114 to reach the office 130.

Bob decides that the cautionary driving notifications stored in the communications apparatus 140 for Jane's use may be inadequate for use by his son Patrick because Patrick is an inexperienced driver and requires a different set of notifications and instructions. Consequently, Bob may opt to modify some or all of the cautionary driving notifications in the communications apparatus 140 and to also add a cautionary driving notification with respect to the intersection 301 and the road 311 that Patrick travels to reach the high school 305. The communications apparatus 140 with the modified and/or additional cautionary driving notifications is handed over to Patrick for use when driving the automobile 210. Patrick may occasionally lend the automobile 210 to his friend Michael under the condition that Michael abides by the cautionary driving notifications provided by Bob via the communications apparatus 140.

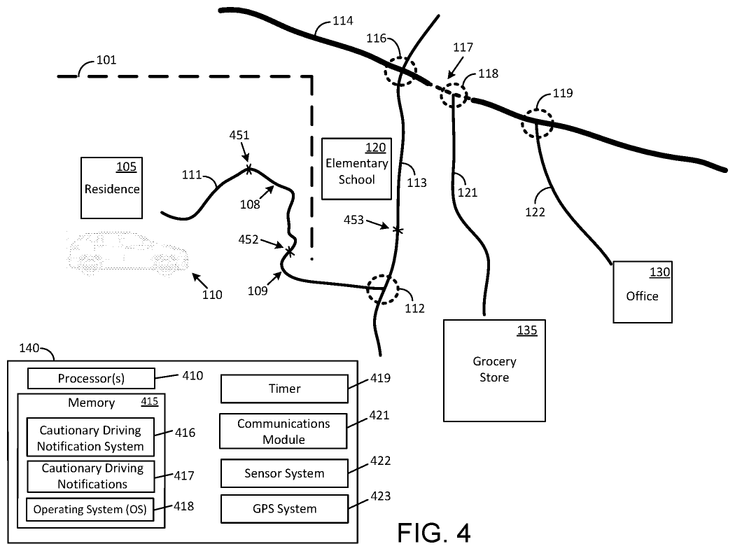

FIG. 4 illustrates some details of an exemplary embodiment of the communications apparatus 140 in accordance with the disclosure. In this exemplary embodiment, the communications apparatus 140 can include various components such as a processor 410 and a memory 415. The communications apparatus 140 can further include some or all components such as a timer 419, a communications module 421, a sensor system 422, and a Global Positioning System (GPS) 423.

The memory 415, which is one example of a non-transitory computer-readable medium, may be used to store an operating system (OS) 418 and various other code modules such as a cautionary driving notification system 416. The memory 415 may also be used to store data and information such as cautionary driving notifications 417. The various code modules can be configured to carry out various operations in cooperation with various types of hardware provided in the automobile 110. For example, the cautionary driving notification system 416 can include one or programs that are executed by the processor 410 to provide cautionary driving notifications over a radio in the automobile 110.

The memory 415 can include any one memory element or a combination of volatile memory elements (e.g., random access memory (RAM, such as DRAM, SRAM, SDRAM, etc.)) and non-volatile memory elements (e.g., ROM, hard drive, tape, CD ROM, etc.). Moreover, the memory device may incorporate electronic, magnetic, optical, and/or other types of storage media. In the context of this document, a “non-transitory computer-readable medium” can be, for example, but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

In the context of software, the operations described herein with respect to the communications apparatus 140 may be implemented by computer-executable instructions stored on one or more non-transitory computer-readable media such as the memory 415, that, when executed by one or more processors such as the processor 410, perform the recited operations. Generally, computer-executable instructions include routines, programs, objects, components, data structures, and the like that perform particular functions or implement particular abstract data types.

In an exemplary implementation, the communications apparatus 140 can include the processor 410, the memory 415, the timer 419, the communications module 421, and the sensor system 422. The Global Positioning System (GPS) 423 is omitted in this exemplary implementation. The sensor system 422 can be coupled to various types of hardware in the automobile 110 for detecting various operations of the automobile 110. For example, the sensor system 422 may be coupled to an ignition system of the automobile 110 in order to detect a starting operation of the automobile 110 and to a speedometer of the automobile 110 in order to determine a speed of motion of the automobile 110.

The timer 419 may be coupled to the sensor system 422 for executing various types of time-related functions. For example, the timer 419 may be used by the processor 410 to determine a first time period between a moment when Bob started the automobile 110 and a moment when Bob generated and stored the first cautionary driving notification at the school bus stop 108. The first time period may then be used by the processor 410 in cooperation with the cautionary driving notification system 416 to determine a location 451 ahead of the school bus stop 108 at which the first cautionary driving notification can be issued in the automobile 110. The communications module 421 can include an output interface that includes a speaker for sounding the first cautionary driving notification. The location 451 may be determined not only by using the time period identified by the timer 419 but also by using the sensor system 422 for identifying various other parameters such as a speed and a braking distance of the automobile 110. The speed and the braking distance may be processed by the processor 410 to determine the location 451 at which the driver (Bob or Jane) has to slow down or stop the automobile 110, before reaching the school bus stop 108.

The timer 419 and the sensor system 422 may be similarly used by the processor 410 to output other cautionary driving notifications such as at a location 452 ahead of the blind curve 109, and a location 453 ahead of the speed zone in front of the elementary school 120. The cautionary driving notifications may be stored in the memory 415, by the processor 410, in the form of cautionary driving notifications 417.

In another exemplary implementation, the communications apparatus 140 can include the processor 410, the memory 415, the communications module 421, the sensor system 422, and the Global Positioning System (GPS) 423. The timer 419 may be omitted in this exemplary implementation. The Global Positioning System (GPS) 423 may be used by the processor 410 in lieu of the timer 419 for identifying various locations such as the location 451, the location 452, and the location 453 at which cautionary driving notifications are output by the communications module 421 via a radio in the automobile 110 for example.

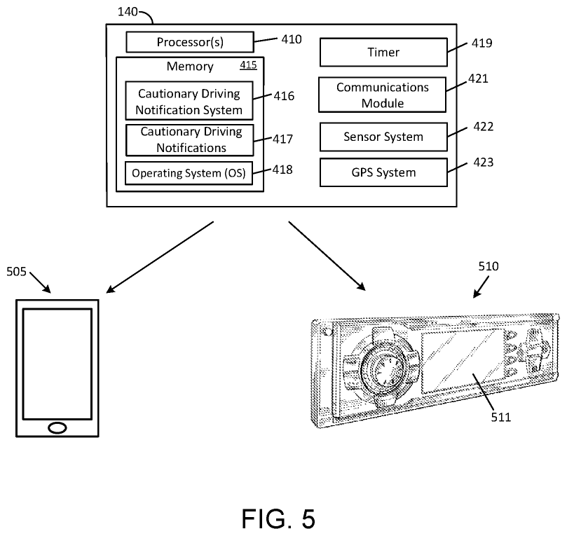

FIG. 5 illustrates a few exemplary devices that may be used to provide cautionary driving notifications in accordance with the disclosure. The first exemplary device is a smartphone 505 containing some or all components of the communications apparatus 140. In one exemplary embodiment, the cautionary driving notification system 416 of the communications apparatus 140 may be provided in the form of an app that is downloaded into the smartphone 505 from a suitable source such as a cloud storage device or a memory card.

In one exemplary implementation, Bob generates the cautionary driving notifications by speaking into a microphone of the smartphone 505. The spoken cautionary driving notifications are stored in the memory 415 which is located inside the smartphone 505. The cautionary driving notifications are automatically output from a speaker of the smartphone 505 in Bob's original voice when the automobile 110 (or the automobile 210) reaches various locations such as the location 451, the location 452, and the location 453 illustrated in FIG. 4.

In another exemplary implementation, Bob generates the cautionary driving notifications by entering text into the smartphone 505. The text messages are stored in the memory 415 which is located inside the smartphone 505. The cautionary driving notifications are automatically output from the speaker of the smartphone 505 in a machine-generated voice when the automobile 110 (or the automobile 210) reaches various locations such as the location 451, the location 452, and the location 453 illustrated in FIG. 4.

In yet another exemplary implementation, Bob generates the cautionary driving notifications by depressing one or more keys on the smartphone 505. The one or more keys, which may be dedicated keys associated with the communications apparatus 140, are recognized when depressed, and one or more key activation events are stored by the processor 410 in the form of the cautionary driving notifications 417 in the memory 415. The cautionary driving notifications are output from the speaker system of the smartphone 505 by the processor 410 in the form of sounds such as a beep or a series of beeps when the automobile 110 or the automobile 210 reaches various locations such as the location 451, the location 452, and the location 453 illustrated in FIG. 4.

The second exemplary device that may be used to provide cautionary driving notifications in accordance with the disclosure is an infotainment system 510 of the automobile 110 (or the automobile 210). Some or all of the components of the communications apparatus 140 may be incorporated into the infotainment system 510.

In one exemplary implementation, Bob generates the cautionary driving notifications by speaking into a microphone that is wirelessly coupled to the infotainment system 510. The wireless coupling may utilize a communications format such as Bluetooth®. The spoken cautionary driving notifications may be processed by the processor 410 and stored in the form of the cautionary driving notifications 417 in the memory 415. The cautionary driving notifications may be output from the speaker system of the infotainment system 510 in Bob's original voice when the automobile 110 or the automobile 210 reaches various locations such as the location 451, the location 452, and the location 453 illustrated in FIG. 4.

In another exemplary implementation, the cautionary driving notifications may be provided in the form of machine-generated audio messages or audio tones that are output from one or more speakers coupled to the infotainment system 510. In yet another exemplary implementation, the cautionary driving notifications can be displayed as graphics on a display screen 511 of the infotainment system 510.

It should be understood that the smartphone 505 and the infotainment system 510 are merely two examples of devices that may be used to implement the communications apparatus 140. In other embodiments, various devices such as laptops, tablet computers, and MP3 players may be used in lieu of, or in addition to, the smartphone 505 and the infotainment system 510.

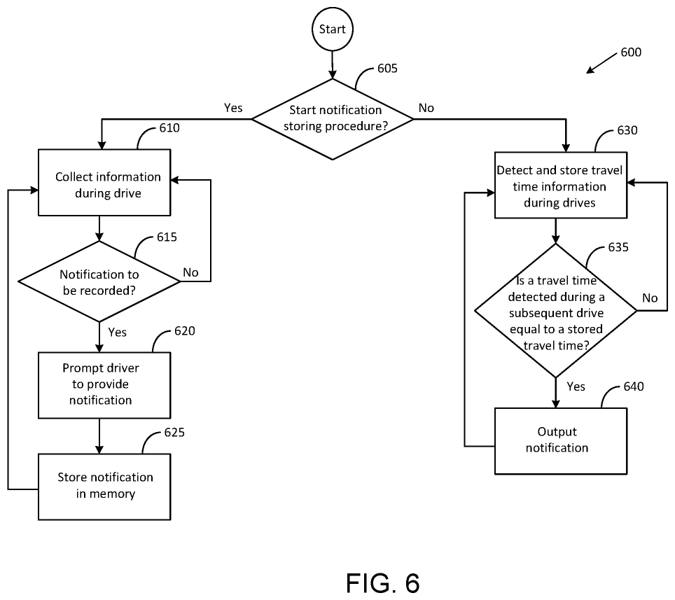

FIG. 6 is a flowchart 600 of an exemplary method to provide cautionary driving notifications in accordance with the disclosure. The flowchart 600 illustrates a sequence of operations that can be implemented in hardware, software, or a combination thereof. In the context of software, the operations represent computer-executable instructions stored on one or more non-transitory computer-readable media such as the memory 415, that, when executed by one or more processors, such as the processor 410, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 600 may be carried out by using an application such as the cautionary driving notification system 416 that is stored in the memory 415 of the communications apparatus 140.

At block 605, the communications apparatus 140 provides to a driver of an automobile a query to inquire if a cautionary driving notification procedure is to be started. The driver may offer one of two answers. If the answer is yes, at block 610, the cautionary driving notification procedure is started by the communications apparatus 140. The procedure may include collecting various types of information pertaining to the travel route. For example, the timer 419 may be used to identify a travel time of the automobile from the residence 105 to the school bus stop 108. As another example, the GPS system 423 may be used to identify GPS coordinates of the location 451 that is ahead of the school bus stop 108 along the travel route of the driver from the residence 105 to the office 130.

At block 615, the communications apparatus 140 checks for input from the driver. If no input is provided, the information collection activities performed at block 610 are continued. On the other hand, if the driver indicates that he/she would like to generate a cautionary driving notification, the communications apparatus 140 prompts the driver to provide the cautionary driving notification (block 620).

The cautionary driving notification may be provided by the driver in one or more ways such as by speaking into a microphone of the communications apparatus 140, entering text via a keypad of the communications apparatus 140, and/or depressing keys on the keypad of the communications apparatus 140.

At block 625, the cautionary driving notification provided by the driver may be processed by the processor 410 and stored in the memory 415 as a first cautionary driving notification in the cautionary driving notifications 417. Upon completion of the storing activity at block 625, operations are recursively resumed at block 610 and additional cautionary driving notifications can be generated by the driver such as, for example, another cautionary driving notification pertaining to the blind curve 109.

If the input provided by the driver at block 605 is no, at block 630, various types of information pertaining to the travel route are collected. For example, the timer 419 may be used to detect a time duration from a start time of the automobile 110 from the residence 105 to a current location of the automobile moving along the travel route during one or more drives in the automobile 110. At block 635, a determination is made whether the detected time duration of a subsequent drive in the automobile 110 is equal to the travel time stored in the memory 415 (at block 625) to reach the location 451 ahead of the school bus stop 108. At block 640, the communications apparatus 140 outputs the cautionary driving notification that was provided by the driver at block 620 and block 625.

The operations at block 630, block 635, and block 640 are recursively executed for outputting any additional cautionary driving notifications that may be stored in the memory 415.

### EXAMPLE EMBODIMENTS

In some instances, the following examples may be implemented together or separately by the systems and methods described herein.

Example 1 may include a method comprising: storing, in a communications apparatus, a cautionary driving notification that is provided to the communications apparatus by a first driver to indicate at least one of a driving hazard or a driving limitation encountered by the first driver when driving along a first travel route; and communicating, by the communications apparatus, the cautionary driving notification to at least one of a friend or a relative of the first driver when the one of the friend or the relative drives along the first travel route.

Example 2 may include the method of example 1, wherein each of the first driver and the one of the friend or the relative utilize a first automobile when driving along the first travel route.

Example 3 may include the method of example 1 and/or some other example herein, wherein the cautionary driving notification is provided by the first driver to the communications apparatus after the first driver has encountered the at least one of the driving hazard or the driving limitation two or more times when driving along the first travel route.

Example 4 may include the method of example 1 and/or some other example herein, wherein the at least one of the driving hazard or the driving limitation is encountered by the first driver each of two or more times when driving along the first travel route.

Example 5 may include the method of example 1 and/or some other example herein, wherein the at least one of the driving hazard or the driving limitation is encountered by the first driver each of two or more times when driving along the first travel route during at least a first time-segment of the day.

Example 6 may include the method of example 5 and/or some other example herein, wherein the first time-segment of the day is associated with a speed limit imposed on a road during school hours.

Example 7 may include the method of example 4 and/or some other example herein, wherein the at least one of the driving hazard or the driving limitation is due to at least one of a construction project, a malfunctioning traffic light, or a traffic accident.

Example 8 may include a method comprising: encountering, by a first driver of a first automobile, at least one of a driving hazard or a driving limitation when driving along a first travel route; storing, in a communications apparatus, a cautionary driving notification indicating the at least one of the driving hazard or the driving limitation; and communicating, by the communications apparatus, to at least a second driver of the first automobile, the cautionary driving notification, to alert the second driver of the at least one of the driving hazard or the driving limitation.

Example 9 may include the method of example 8, further comprising: communicating, by the communications apparatus, to the second driver, the cautionary driving notification, when the second driver is driving a second car along the first travel route.

Example 10 may include the method of example 8 and/or some other example herein, wherein the cautionary driving notification is communicated by the communications apparatus to the second driver before the first automobile reaches a location that is associated with the at least one of the driving hazard or the driving limitation.

Example 11 may include the method of example 8 and/or some other example herein, wherein the at least one of the driving hazard or the driving limitation is encountered by the first driver each of two or more times when driving along the first travel route.

Example 12 may include the method of example 8 and/or some other example herein, wherein the at least one of the driving hazard or the driving limitation is a speed limit that is encountered by the first driver during at least a first time-segment of the day.

Example 13 may include a system comprising: a communications apparatus comprising: a communications module; at least one memory that stores computer-executable instructions; and at least one processor configured to access the at least one memory and execute the computer-executable instructions to at least: receive, through the communications module, from a first driver, a cautionary driving notification that indicates at least one of a driving hazard or a driving limitation encountered by the first driver when driving along a first travel route; and communicate, through the communications module, to a second driver, the cautionary driving notification.

Example 14 may include the system of example 13 and/or some other example herein, wherein the communications apparatus is at least one of an infotainment apparatus located in an automobile.

Example 15 may include the system of example 14 and/or some other example herein, wherein the communications apparatus further comprises a GPS system and a timer, and wherein the at least one processor is further configured to execute the computer-executable instructions to communicate the cautionary driving notification to the second driver based on at least location information provided by the GPS system and time information provided by the timer.

Example 16 may include the system of example 15 and/or some other example herein, wherein the GPS system and a timer are configured to automatically store location information and time information of the at least one of the driving hazard or the driving limitation.

Example 17 may include the system of example 16 and/or some other example herein, wherein the at least one of the driving hazard or the driving limitation is a speed limit imposed on a road during school hours.

Example 18 may include the system of example 13, wherein the first recordation input is stored in the at least one memory, wherein the communications module comprises a voice synthesizer, and wherein the cautionary driving notification is communicated to the second driver by the voice synthesizer.

Example 19 may include the system of example 18 and/or some other example herein, wherein the cautionary driving notification is communicated to the second driver by one of a message or one or more beeping sounds.

Example 20 may include the system of example 18 and/or some other example herein, wherein the communications module comprises one of a voice input system or a text input system.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein.

An implementation of the devices, systems, and methods disclosed herein may communicate over a computer network provided in the automobile 110 and/or the automobile 210. A “network” and a “bus” is defined as one or more data links that enable the transport of electronic data between computer systems and/or modules and/or other electronic devices. When information is transferred or provided over a network, a bus, or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
storing, in a communications apparatus, a cautionary driving notification that is provided to the communications apparatus by a first driver to indicate at least one of a driving hazard or a driving limitation encountered by the first driver when driving along a first travel route; and
communicating, by the communications apparatus, the cautionary driving notification to at least one of a friend or a relative of the first driver when the one of the friend or the relative drives along the first travel route.

2. The method of claim 1, wherein each of the first driver and the one of the friend or the relative utilize a first automobile when driving along the first travel route.

3. The method of claim 1, wherein the cautionary driving notification is provided by the first driver to the communications apparatus after the first driver has encountered the at least one of the driving hazard or the driving limitation two or more times when driving along the first travel route.

4. The method of claim 1, wherein the at least one of the driving hazard or the driving limitation is encountered by the first driver each of two or more times when driving along the first travel route.

5. The method of claim 1, wherein the at least one of the driving hazard or the driving limitation is encountered by the first driver each of two or more times when driving along the first travel route during at least a first time-segment of the day.

6. The method of claim 5, wherein the first time-segment of the day is associated with a speed limit imposed on a road during school hours.

7. The method of claim 4, wherein the at least one of the driving hazard or the driving limitation is due to at least one of a construction project, a malfunctioning traffic light, or a traffic accident.

8. A method comprising:
encountering, by a first driver of a first automobile, at least one of a driving hazard or a driving limitation when driving along a first travel route;
storing, in a communications apparatus, a cautionary driving notification indicating the at least one of the driving hazard or the driving limitation; and
communicating, by the communications apparatus, to at least a second driver of the first automobile, the cautionary driving notification, to alert the second driver of the at least one of the driving hazard or the driving limitation.

9. The method of claim 8, further comprising:
communicating, by the communications apparatus, to the second driver, the cautionary driving notification, when the second driver is driving a second car along the first travel route.

10. The method of claim 8, wherein the cautionary driving notification is communicated by the communications apparatus to the second driver before the first automobile reaches a location that is associated with the at least one of the driving hazard or the driving limitation.

11. The method of claim 8, wherein the at least one of the driving hazard or the driving limitation is encountered by the first driver each of two or more times when driving along the first travel route.

12. The method of claim 8, wherein the at least one of the driving hazard or the driving limitation is a speed limit that is encountered by the first driver during at least a first time-segment of the day.

13. A system comprising:
a communications apparatus comprising:
a communications module;
at least one memory that stores computer-executable instructions; and
at least one processor configured to access the at least one memory and execute the computer-executable instructions to at least:
receive, through the communications module, from a first driver, a cautionary driving notification that indicates at least one of a driving hazard or a driving limitation encountered by the first driver when driving along a first travel route; and
communicate, through the communications module, to a second driver, the cautionary driving notification.

14. The system of claim 13, wherein the communications apparatus is at least one of an infotainment apparatus located in an automobile.

15. The system of claim 14, wherein the communications apparatus further comprises a GPS system and a timer, and wherein the at least one processor is further configured to execute the computer-executable instructions to communicate the cautionary driving notification to the second driver based on at least location information provided by the GPS system and time information provided by the timer.

16. The system of claim 15, wherein the GPS system and a timer are configured to automatically store location information and time information of the at least one of the driving hazard or the driving limitation.

17. The system of claim 16, wherein the at least one of the driving hazard or the driving limitation is a speed limit imposed on a road during school hours.

18. The system of claim 13,
wherein the first recordation input is stored in the at least one memory,
wherein the communications module comprises a voice synthesizer, and
wherein the cautionary driving notification is communicated to the second driver by the voice synthesizer.

19. The system of claim 18, wherein the cautionary driving notification is communicated to the second driver by one of a message or one or more beeping sounds.

20. The system of claim 18, wherein the communications module comprises one of a voice input system or a text input system.
